(19) United States
(12) Patent Application Publication
(10) Pub. No.: US 2003/0229540 A1
(43) Pub. Date: Dec. 11, 2003

(54) Rebate issuance and reconciliation systems and methods

(75) Inventor: Kenneth Algiene, Littleton, CO (US)

Correspondence Address: TOWNSEND AND TOWNSEND AND CREW, LLP, TWO EMBARCADERO CENTER, EIGHTH FLOOR, SAN FRANCISCO, CA, 94111-3834, US

(73) Assignee: First Data Corporation, Greenwood Village, CO (US)

(21) Appl. No.: 10/238,044

(22) Filed: Sep. 9, 2002

Related U.S. Application Data
(63) Continuation-in-part of application No. 10/167,720, filed on Jun. 10, 2002.

(51) Int. Cl. G06F 17/60

(52) U.S. Cl. 705/14

(57) ABSTRACT

Systems and methods are disclosed for providing rebates. A host computer receives information associated with at least one item for sale and reimbursement information relating to the rebate. The host computer also receives redemption information on a redeemed rebate. The host computer transmits a request for reimbursement based on the reimbursement information and the redemption information.

### CROSS REFERENCES TO RELATED APPLICATIONS

This application is a continuation in part application of U.S. application Ser. No. 10/167,720, filed Jun. 10, 2002, the complete disclosure of which is herein incorporated by reference.

### BACKGROUND OF THE INVENTION

This invention relates generally to the field of rebates. More specifically, the invention relates to various types of rebates that may be provided at the time of purchase.

Rebates are a popular way for merchants to market their goods or services. Unfortunately, the process for obtaining a rebate following the purchase of an item can be difficult, time consuming and frustrating for the consumer. For example, one typical process for obtaining a rebate requires the consumer to submit a host of paperwork to the manufacturer to request the rebate. This paperwork may include: a rebate form, a receipt of purchase, a proof of purchase, such as a UPC symbol cut from the packaging, and the like. If any of the required paperwork is missing, if the rebate form is filled out incorrectly, or if certain deadlines are not met, the rebate may be denied. This process may become more frustrating because the proper rebate form may be difficult or time consuming to locate. Further, even if the process is properly followed, the time to actually receive the rebate can be extremely time consuming, sometimes being six months or more. In some cases, this is because manufacturers may contract with special rebate companies to handle their rebates. If a rebate is delayed or the paperwork is lost, the consumer faces an uphill battle in following up with the manufacturer to make sure the rebate is paid. For example, if the consumer does not make a copy of the paperwork, the consumer has no way of proving that the item was purchased.

While some reforms to this process have been implemented, such as by posting rebate forms in the store or on-line, the process is still time consuming and frustrating to the consumer. Moreover, the consumer may still face significant time delays in receiving the rebate.

### BRIEF SUMMARY OF THE INVENTION

The invention provides various methods, systems and devices for providing rebates. According to one method, information on an item being purchased is received at a host computer. Also received at the host computer is a request to receive a rebate that is associated with the item. This information may conveniently be transmitted to the host computer from a point of sale device where the item is purchased. The host computer may transmit to a payment device information usable by the payment device to provide the rebate. In this way, information needed to qualify for a rebate may be electronically gathered at the time of sale and used to generate the rebate.

In one aspect, the host computer may be employed to determine whether a rebate is associated with the item based on the information transmitted from the point of sale device. The host computer may then transmit to the point of sale device information indicating that a rebate applies. In some cases, the point of sale device may be used to determine whether a rebate is associated with the item.

Once a rebate has been qualified for or requested, a variety of payment options may be selected. These options may be provided to the consumer at the point of sale device. Further, the selected option may be entered into the point of sale device and transmitted to the host computer. For example, in one aspect the payment device may comprise a printer. In this way, the host computer may transmit information usable by the printer to print a negotiable instrument, such as a money order or a check. As another option, the printer may print a rebate coupon. The rebate coupon may conveniently include some or all information needed to qualify for the rebate. For example, the printer may print information into the required fields of the rebate coupon, such as the purchaser's name, address and phone number (or other personal information), the date and time of the purchase, the store where the item was purchased, a UPC symbol associated with the purchased item, and the like. To do so, the host computer system may be configured to access the rebate rules associated with the purchased item and to use the information supplied by the purchaser when making the purchase to satisfy the rules. This information is then printed on the rebate coupon. The purchaser may then mail the completed rebate coupon to redeem the rebate.

In another alternative, the payment device may comprise a cash dispensing machine, such as an ATM, and the host computer may transmit information to the cash dispensing machine to dispense the rebate in cash. As a further option, the payment device may comprise an electronic account, such as a bank account, credit account, stored value account, investment account, or the like. The host computer may then transmit information to the electronic account to apply a rebate credit to the account.

In another embodiment, the invention provides a computer system for providing rebates. The system comprises a host computer having an input interface and an output interface. Further, a memory device is associated with the host computer. The host computer is configured to receive at the input interface information on an item being purchased as well as a request to receive a rebate that is associated with the item. The output interface is configured to transmit to a payment device information usable by the payment device to provide the rebate. In one aspect, the memory device may include information on rebate rules. In this way, the host computer may be used to determine whether a rebate is associated with the item using the rebate rules.

The system may also include a point of sale device that comprises a housing having a display screen, at least one entry device, a memory, a processor, and a communication device. The point of sale device may be used to receive information on an item being purchased using the entry device and to transmit this information to the host computer. The point of sale device may also be used to receive information from the consumer requesting that the rebate be provided, and to transmit this information to a host computer using the communication device.

In some cases, the memory may include rebate rules so that the point of sale device may be used to determine whether a rebate is associated with the item. In another option, the point of sale device may be configured to request an input as to whether the rebate is to be provided using the display screen.

In one option, a record indicating that the rebate has been provided to the consumer may be stored. This may be transmitted to the vendor or retailer for accounting purposes. This record may also be used in the event that the consumer wishes to return the item.

The system may utilize a variety of payment devices. For example, the payment device may comprise a printer to print negotiable instruments or rebate coupons based on information supplied from the host computer. As another example, the payment device may comprise a cash dispensing machine for dispensing cash. As a further example, the payment device may comprise an electronic account to which the rebate may be credited based on information transmitted from the host computer.

Embodiments of the invention also provide reconciliation of the rebate. This may be achieved by integrating the host computer system with a financial network that may provide transfer instructions for accounts associated with the manufacturer and retailer of an item. Thus, the host computer receives rebate information associated with the item, reimbursement information relating to the rebate, and redemption information on a redeemed rebate. The host computer then transmits a request for reimbursement based on the reimbursement information and the redemption information. This request for reimbursement may include an instruction to debit an account associated with the manufacturer of the item and/or may include an instruction to credit an account associated with the retailer. The information regarding both the item to which the rebate is applied and the rebate itself may be extracted by reading a bar code from the item and/or rebate. This reconciliation may be performed in real time by issuing the request for reimbursement substantially contemporaneously with redemption of the rebate, or may be performed in a batch mode by accumulating rebate information throughout a time period and issuing multiple requests for reimbursement at the end of the time period.

These methods may be implemented by a computer system that comprises a host computer having an input interface and an output interface, and a memory associated with the host computer. The host computer is configured to receive the rebate information associated with the item, the reimbursement information relating to the rebate, and the redemption information on the redeemed rebate at the input interface. The request for reimbursement is transmitted at the output interface.

In another embodiment, the reconciliation is coordinated by a payment system that receives rebate information from multiple retailers, each set of information setting forth a plurality of redeemed rebates that may be associated with multiple manufacturers. Instructions are transmitted by the payment system to financial institutions respectively to debit an account for at least one of the manufacturers and to credit an account for at least one of the retailers. The amounts to debit and credit may be determined by deriving a total debit amount for each of the manufacturers from the information and by deriving a total credit amount for each of the retailers. In some instances, the total debit and credit amounts may also account for service charges.

These reconciliation methods may also be implemented by a computer system that comprises a payment-system computer having an input interface and an output interface, and a memory associated with the payment-system computer. The payment-system computer is configured to receive the information from the multiple retailers at the input interface and to issue the instructions for debiting and crediting account at the output interface.

### BRIEF DESCRIPTION OF THE DRAWINGS

FIG. 1 is a schematic diagram of a system for providing rebates according to the invention.

FIG. 2 is a schematic diagram of a point of sale device that may be used with the system of FIG. 1.

FIG. 3 illustrates a display screen of the point of sale device of FIG. 2 that displays a query as to whether a rebate is wanted.

FIG. 4 illustrates a display screen of the point of sale device of FIG. 2 that displays a query as to the form of the rebates.

FIG. 5 is a flow chart illustrating one method for providing a rebate according to the invention.

FIG. 6A is a schematic diagram of a system for providing rebates in an embodiment of the invention.

FIG. 6B is a flow diagram illustrating a method for providing a rebate in an embodiment of tie invention.

### DETAILED DESCRIPTION OF THE INVENTION

The invention provides various systems and techniques for providing rebates to consumers. Such rebates may be provided to the consumer at or near the time of purchase, or at another time as selected by the consumer. Further, the consumer may select to receive the rebate at the location where the item is purchased, or at a remote location. As another option, the consumer may elect the form in which the rebate is to be paid. As used herein, a rebate may include any type of value that may be represented in the form of a payment instrument, such as a negotiable instrument, a coupon, a card, or the like. For example, the consumer may request the rebate to be paid in the form of a negotiable instrument, such as cash, a check, a money order, or the like. As another example, the rebate may be in the form of a credit to an account of the consumer, such as a bank account, a credit account, an investment account, a stored value account, or the like. As a further example, the rebate may comprise any one of a variety of coupons, such as discounts off a subsequent purchase, offers for free items or services, free items with the purchase of another item, or the like.

In some cases, a message may be provided to the consumer giving the status of a rebate. For example, when making a purchase the consumer may be provided with information as to how many more purchases are needed within a certain time before qualifying for rebate. This information may be displayed on a point of sale device. Optionally, this information could be printed on a receipt using the point of sale device. A similar processing may be used when a consumer qualifies for a rebate whether or not the consumer chooses to redeem the coupon at that time.

The invention may also use a value exchange engine that permits an earned rebate to be exchanged for another type of rebate. This may be accomplished in a manner similar to that described in copending application Ser. No. 09/955747, filed Sep. 18, 2001 (020375-000300US), the complete disclosure of which is incorporated by reference. Hence, after qualifying for a rebate, the consumer may request that it be exchanged for another type of rebate that may then be printed out and provided to the consumer. For example, if the consumer qualifies for a coupon, the consumer may request that this be converted to a negotiable instrument. For instance, a coupon for a free soda may be converted to a negotiable instrument. The host computer system may use a rules engine to determine the conversion, such as 25 cents. If this is accepted by the consumer, a file may be sent to the printer to print a 25 cent money order. As another example, a coupon for a free candy bar may be exchanged for a buy one get one free coupon for ice cream. The rules engine may be programmed to provide possible value exchanges.

One particular advantage of the invention is that all of the information needed to qualify for a rebate may be provided at the time of purchase. For example, when purchasing an item, information about the item is typically scanned into a computer, often using a bar code reader. This information may also be used to determine the price of the item. Many retailers also request information about the consumer and enter this into the computer. For example, when making a purchase, the consumer may provide a loyalty card that is scanned into the computer. Types of information that may be requested may include phone number, zip code, name, address and the like. In this way, the purchases may be associated with information about the consumer that is stored within a database. As another example, information about the consumer may be directly entered into a point of sale device, or obtained from records associated with the consumer's credit or debt card that is used to make payment.

Hence, at the point of sale a wide variety of information associated with the purchase of the item may be electronically stored, such as the name of the item, the price of the item, the time and location of the purchase, the form of payment used to make the purchase, and personal information on the consumer. This information may then be electronically processed to determine if the consumer qualifies for a rebate. If so, the consumer may elect to receive the rebate according to a variety of options. In this way, the consumer is not required to separately submit a host of paperwork in order to qualify for a rebate. Moreover, the consumer may be provided with a variety of options as to how the rebate may be paid, such as when, where and how the rebate is to be paid.

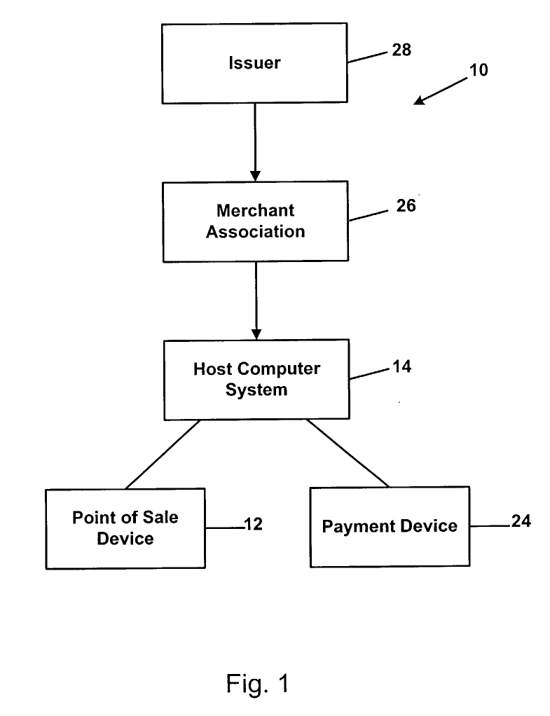

Referring now to FIG. 1, one embodiment of a system 10 for providing rebates will be described. System 10 comprises a point of sale device 12 that communicates with a host computer system 14. Point of sale device 12 may be employed to capture information needed to complete the purchase of an item. As such, point of sale device 12 may include associated equipment, devices and the like that are used in making a transaction. For instance, when making a purchase, bar code information may be scanned from the item and used to extract information about the item from a database. Also, information from consumer loyalty cards may be scanned in a similar manner. Point of sale device 12 may be configured to incorporate or communicate with any such devices or systems. Further, point of sale device 12 may include other components to facilitate a purchase, such as payment information entry components, signature capture components, key pads, keyboards, display screens, biometric data capture components, speakers, printers, processors, software, memory, communication devices and the like. Examples of suitable point of sale devices are described in copending U.S. application Ser. No. 10/116689, filed Apr. 3, 2002, entitled Systems and Methods for Performing Transactions at a Point-of-Sale (attorney docket no. 20375-002411), the complete disclosure of which is herein incorporated by reference.

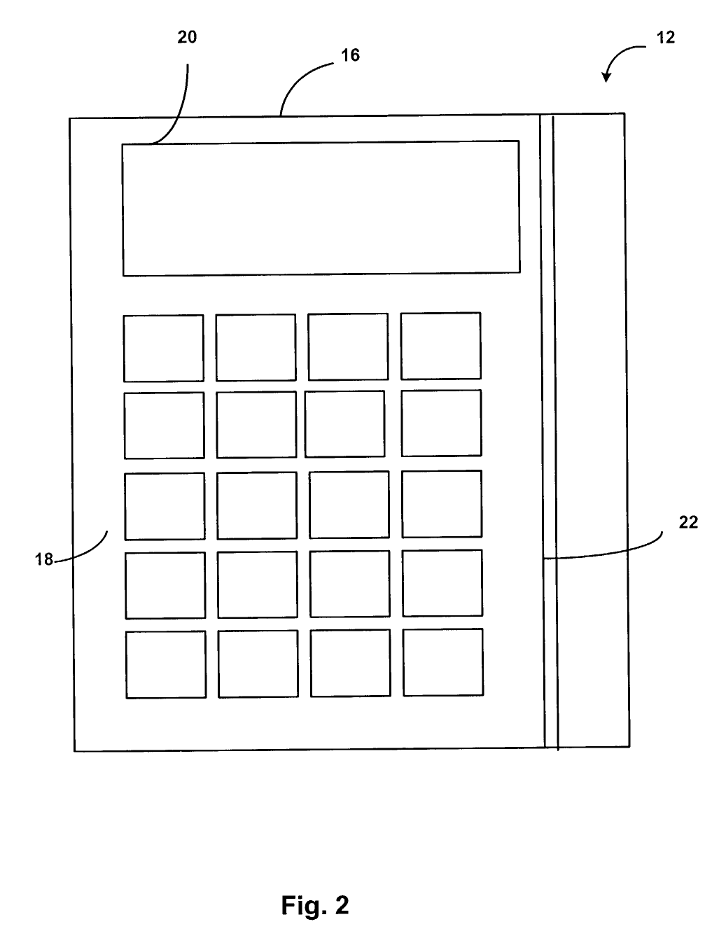

One specific example of how point of sale device 12 may be constructed is illustrated in FIG. 2. Point of sale device 12 comprises a housing 16 having a keypad 18 for entering various types of information. The keys of keypad 18 may permit the entry of numbers of letters, or may be function keys for performing various functions. Device 12 further includes a display screen 20 for displaying information relating to a transaction. A card reader 22 is also provided for reading information from cards, such as payment information, identification information, or the like.

Device 12 may communicate with host computer system 14 using a wide variety of communications systems, such as by a phone network, a wide area network, such as the Internet, a local area network, a wireless network, or the like.

Also in communication with host computer system 14 is a payment device 24. Payment device 24 may communicate with host computer system 14 using any of the networks described above. Payment device 24 is employed to provide the rebate payment to the consumer. In some cases, payment device 24 may directly communicate with point of sale device 12. For instance, point of sale device 12 may be connected to an attached printer, such as an FDX-400 printer, from AXIOHM. Further, in some cases, point of sale device 12 may itself function as a payment device. Payment device 24 may pay rebates in a variety of forms. For example, payment device 24 may comprise a printer that is configured to print negotiable instruments, such as money orders, checks, and the like. These may be printed in the name of the customer since this information may be input into point of sale device 12. Printer 24 may be a secure printer to ensure that negotiable instruments may only be printed based on instructions from host computer system 14. One example of such a secure printer is described in U.S. Pat. No. 5,774,879, the complete disclosure of which is herein incorporated by reference. Printer 24 may conveniently be provided at a location near point of sale device 12, such as at a customer service location or even adjacent to point of sale device 12 itself, so that the consumer may pick up the printed rebate just after making the purchase. In some cases, printer 24 may be coupled to point of sale device 12 so that once the rebate is approved, printing instructions may be transmitted directly from point of sale device 12 to payment device 24.

In one option, payment device 24 may be configured to print a rebate coupon that may be presented in the traditional manner to obtain a rebate. The rebate coupon may be a blank form that is to be filled in by the consumer, or may be filled out based on information obtained using the point of sale device 12. For example, printer 24 may be configured to print some or all of the information needed to complete the coupon directly on the coupon. In this way, the purchase may simply mail the rebate coupon to the location printed on the coupon. Host computer system 14 may be configured to determine what information needs to be printed on the coupon based on the rules stored at host computer system 14. The information needed to complete the coupon may be input at the point of sale device 12 and may include information such as personal information on the purchaser, information regarding the purchase of the item, information on the item, and the like. If additional information is needed, the point of sale device 12 may prompt the customer for this information.

Point of sale device 12 and/or host computer system 14 may log a record of each rebate coupon that is printed. This information may be transmitted to the provider of the rebate for their records. Further, when the rebate provider receives a completed rebate coupon, the rebate provider may access host computer system 14 to make sure that the item was not returned. If so, the rebate may be denied.

In another embodiment, payment device 24 may be a cash dispenser. For example, payment device 24 may comprise a cash register near point of sale device 12 or at a customer service location. When a cash payment is made, information on the payment may be transmitted to host computer system 14 so that the retailer may be credited for the payment.

Payment device 24 may also take the form of an electronic account that may be used to electronically store the rebate. This electronic account may be incorporated into host computer system 14 or may comprise a separate computer system. Once the rebate information is electronically stored, it may be used in a variety of ways to provide the payment to the consumer or a designee of the consumer. For example, while at point of sale device 12, the consumer may indicate that she wishes to receive the rebate at the time that payment is made by directly crediting an account of the consumer. This may be accomplished by inputting the account information into point of sale device 12 using any of its entry devices. For instance, a card having the account information may be swiped through reader 22 (or scanned), or keypad 18 may be used to enter the account information. Other readers that may be used include MICR readers, smart cart readers, and the like. The account information is then transmitted to host computer system 14 and stored as an electronic account. Host computer system 14 or payment device 24 may transmit the request to the appropriate system that handles the account so that the account may be credited as described hereinafter. Such a system may comprise a credit card network, an ACH transfer system, a stored value system, or the like. Host computer system 14 may also be used to debit an account of the manufacturer to complete the transaction.

Alternatively, the electronic account may function as a stored value account to permit the consumer to access the value at a later time using a variety of systems and to receive the payment in a variety of forms. Merely by way of example, any payment system that is capable of interfacing with host computer system 14 or payment device 24 may be used. Such examples may include financial kiosks, ATMs, money transfer systems bill payment systems, credit card systems, banks or other financial institutions, including ACH transfer systems, stored value systems, investment systems, cash payout devices, money order printers, and the like. Examples of such payment systems are described in copending U.S. application Ser. No. 10/045,313, filed Jan. 4, 2002, the complete disclosure of which is herein incorporated by reference. Such systems may be operated by separate entities which may provide access to the consumer through the Internet, voice response systems, customer service representatives, or the like. For example, a consumer may visit a money transfer location and request the money be transferred to another person. At the money transfer location, the request may be transmitted to host system 14 or payment device 24 to complete the transfer. In a similar manner, a cash payout may be made by accessing the account information, making the payment, and providing a corresponding debit to the account. Host system 14 or payment device 24 may also include an interface to permit the consumer to directly access their stored value account. For example, the consumer may log onto a web site and view their account information. From this web site, the consumer may request to transfer the value to a specific account.

Host computer system 14 may optionally be coupled to a credit card transaction network to facilitate the acceptance of credit cards by the merchant when the consumer makes a purchase. In such a case, host computer system 14 may be configured to process credit card transactions for one or more merchant banks. The credit card transaction network further comprises a merchant association computer system 26 and an issuing bank computer system 28. To complete a credit card transaction, a cardholder presents a credit card to purchase goods or services from a merchant. The merchant transmits an authorization request to its merchant bank. As just described, the merchant bank may contract with another entity to maintain computer system 14 that stores and processes account information for the merchant bank's customers. Because the merchant bank typically does not have direct access to information regarding cardholder account status, the merchant bank may forward the request to a card association, such as to merchant associate computer system 26 (e.g., Visa or MasterCard) for authorization.

If the transaction is authorized, an authorization code is returned to the merchant. The merchant completes the sales transaction with the cardholder by delivering the goods or services and obtaining in exchange a ticket representing the cardholder's agreement to pay the card issuer. The ticket is typically a piece of paper (usually signed by the cardholder) or the electronic equivalent. The ticket provides sufficient information to identify the cardholder, the card used, the merchant, and the amount of the sales transaction.

Next, the merchant collects payment for the sales transaction by presenting the ticket to the merchant bank. Typically, the merchant accumulates tickets from a number of sales transactions (e.g., all transactions from one day) and presents a batch of tickets together to the merchant bank. The merchant bank acquires the ticket and deposits funds into the merchant's account. In general, the amount of funds deposited into the merchant's account is less than the amount of the sales transaction by a percentage (the “discount rate”) established between the merchant and the merchant bank. The merchant bank may also maintain a reserve against the merchant account by temporarily withholding part of the funds in order to cover the risk that the merchant bank is not subsequently repaid by a card issuer for any of the merchant's transactions. Funds held in reserve are usually released to the merchant account after some period of time.

The merchant bank then settles with the card issuer by presenting the ticket to the card issuer, e.g., by using issuing bank computer system 28. Settlement requests are generally processed in batches and routed through the card association rather than being sent directly to the card issuer. The card issuer transfers funds to the merchant bank in exchange for the ticket. The amount of funds transferred is, in general, less than the amount of the sales transaction because the card issuer deducts an “interchange fee” reflecting the delay between the card issuer's payment to the merchant bank and the cardholder's payment to the card issuer. At some point after settlement, the card issuer bills the cardholder for the full amount of the transaction, and the cardholder pays the card issuer according to the terms of their agreement.

In a transaction where a private label credit card is used, the processing is similar, except that the merchant bank and the card issuer are generally the same entity. Thus, the merchant bank is able to authorize the transaction, and a settlement between the card issuer and the merchant bank is not required.

While processing the credit card transaction, such as when the transaction is being authorized, host computer system 14 may determine if the consumer qualifies for a rebate. If the consumer qualifies, and requests the rebate be credited to his credit card account, host computer system 14 may transmit the credit to the issuing bank computer system 28. A similar process may be used to credit a bank account using an ACH transfer, or to credit a stored value account of a retail association.

In the event that the item is returned following the payment of a rebate, host computer system 14 may be accessed to determine whether a rebate was paid. If so, the consumer may be credited for the purchase price less the amount of the rebate.

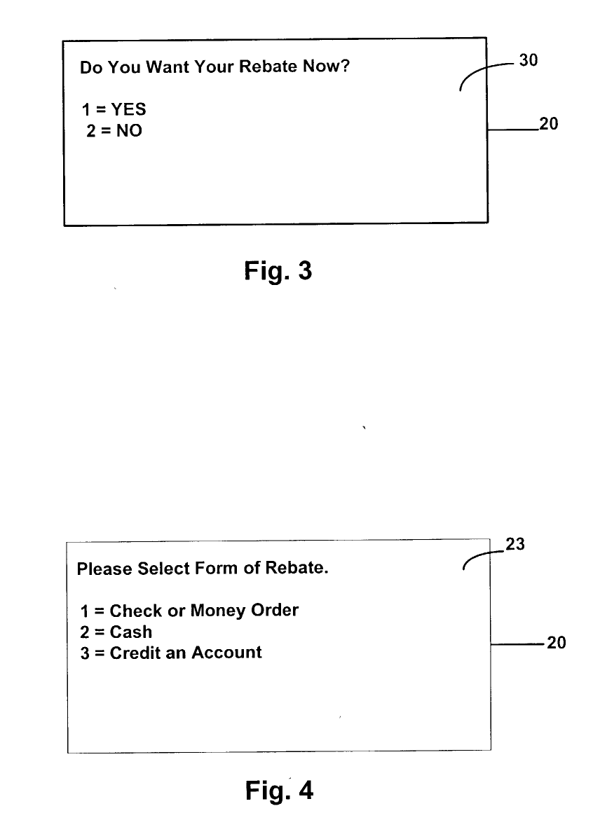

As illustrated in FIG. 3, point of sale device 12 may be configured to produce a display 30 on display screen asking the consumer whether she wishes to receive the rebate at the time of purchase. A response to the question may be entered using keypad 18 (see FIG. 2). This query may be generated by software stored in point of sale device 12 or from information transmitted from host computer system 14. If the consumer decides not to receive the rebate at the time of purchase, an electronic record of the rebate may be stored so that the consumer may receive the rebate by accessing the electronic record using any of the techniques described herein. Of course, the rebate may also be obtained in the traditional manner.

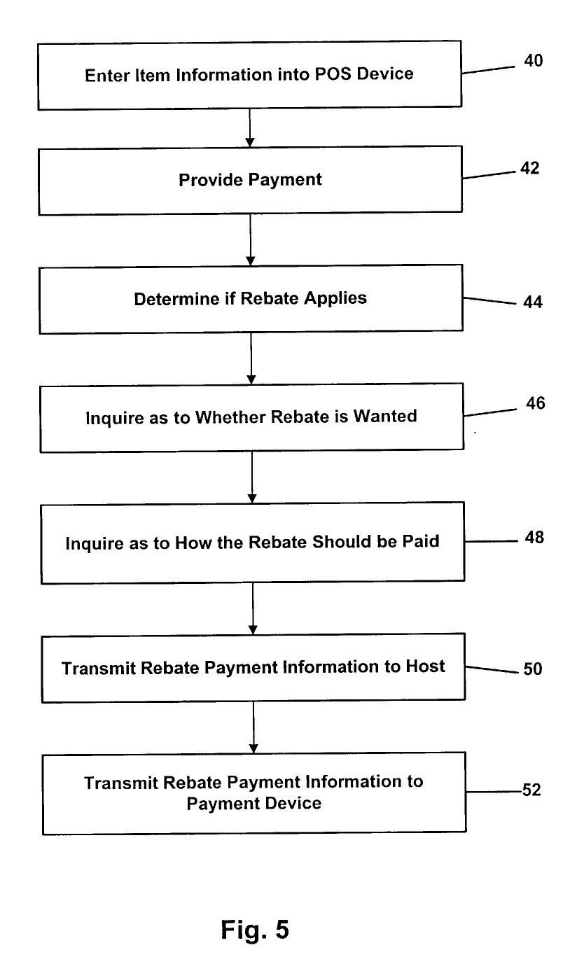

If the consumer decides to receive the rebate at the time of purchase, the consumer may be provided with various options for selecting the form of payment. For example, FIG. 4 illustrates a display 32 of display screen 20 having various options for receiving the rebate. These options may be selected using keypad 18. If a check or money order is selected, a file may be transmitted to a printer to permit the negotiable instrument to be printed. If cash is selected, a cash payment may be made to the consumer, and the amount of payment entered into point of sale device 12 so that the retailer may be credited. If the consumer elects to credit an account, an electronic record of the rebate may be stored so that the consumer may subsequently receive the rebate using any of the techniques described herein.

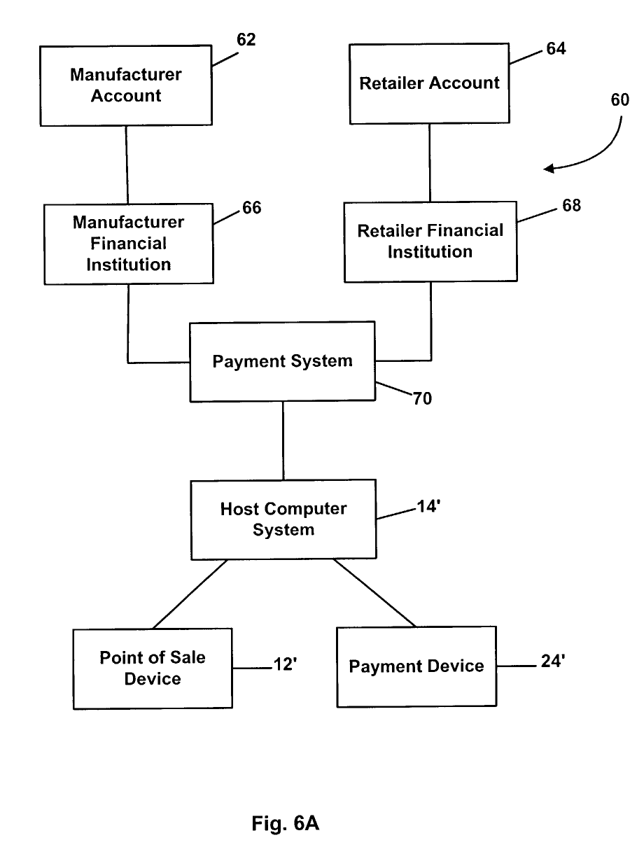

Referring now to FIG. 5, one method for providing a rebate will be described. Initially, the consumer selects the item and provides it to the merchant. The merchant enters information regarding the item into point of sale device 12 as shown in step 40. This may be accomplished by scanning a bar code on the item with a scanner and transmitting this information to point of sale device 12. The consumer also provides payment for the item as shown in step 42. If the payment is made using a credit or debit card, the card may be swiped through point of sale device 12 as previously described. If payment is made by cash or check, a record of the type of payment may be input into point of sale device 12 for storage at host computer system 14.

At step 44, a determination as to whether a rebate applies is made. This determination may be based on rules stored in point of sale device 12 or in host computer system 14. Conveniently, this determination may be made while the consumer's credit card is being authorized. As an example of the rules that may be applied, a manufacturer may offer a $15 rebate if the consumer purchases two of its products at the same time. Point of sale device 12 may then transmit information on the items purchased to host computer system 14 that verifies the products and determines that the consumer qualifies for the rebate. This information is then transmitted back to point of sale device 12.

As shown in step 46, the consumer may then be asked whether she wishes to receive the rebate now or at a later time. Conveniently, a response to this query may be input into point of sale device 12 and transmitted to host computer system 14. If the consumer wishes to receive the rebate at a later time, an electronic record of the rebate is stored so that the consumer may access the electronic record to receive payment using any of the techniques described herein. If the consumer wishes to receive payment at the time of purchase, the consumer is asked the form of payment of the rebate as shown in step 48. The form of payment may be any of the forms described herein. A response to this question may conveniently be input into point of sale device 12 and transmitted to host computer system 14 as shown in step 50.

Based on the response from the consumer, a command may be sent to the payment device to provide the payment to the consumer as shown in step 52. For example, if the consumer wishes to receive payment by a check or money order, point of sale device 12 or host computer system 14 may send instructions to a printer to print the requested negotiable instrument. The consumer may then receive the printed negotiable instrument while at the store. In this way, the rebate qualification information is captured at the point of sale, and the consumer is also able to receive the rebate at essentially the same time and place of sale.

Host computer system 14 may store a record that the consumer has qualified for rebate. This information may be transmitted to an accounting system of the ultimate provide of the rebate. Information on when the rebate has been provided to the consumer may also be transmitted. In this way, the rebate provider will have a record of rebates that have been both qualified for and redeemed. This information may be transmitted electronically, by facsimile, by post, or the like. Information on redemption may also be accessed when an item is returned so that the full price will not be paid back to the consumer.

As one option, when such information is provided to the rebate provider, it may include privacy preferences supplied by the consumer. For example, the consumer may indicate at the time of purchase that they would like not marketing materials from the rebate provider, or would like only selected materials or would like any materials.

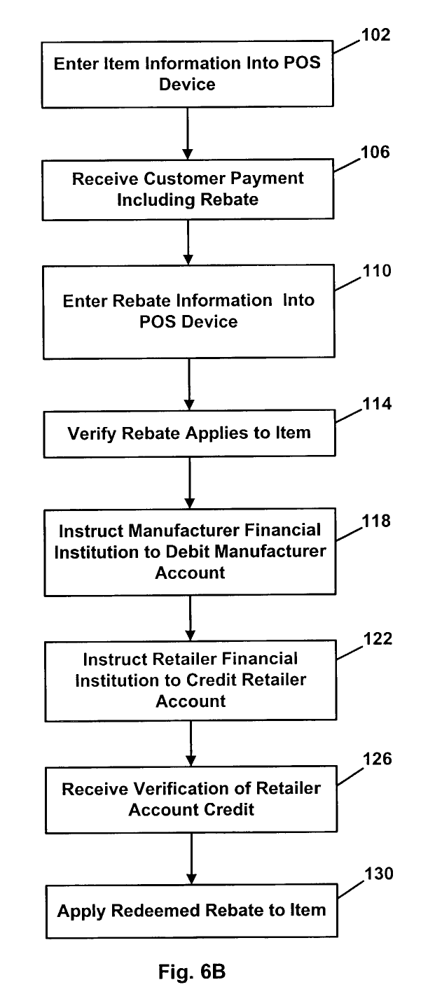

Embodiments of the invention also permit effective reconciliation of a rebate when it is redeemed and, in some embodiments, permit such reconciliation to occur in real time at the time of redemption by a consumer. This is accomplished by integrating the host computer system with a financial network, to permit real-time transfers of funds in accordance with the rebate. Such an integration is illustrated with the system configuration 60 shown in FIG. 6A and with a corresponding flow diagram showing one embodiment of a method using that configuration in FIG. 6B. The system 60 shown in FIG. 6A may include a host computer system 14′ similar to that shown in FIG. 1. The reference labels for the host computer system 14′, point-of-sale device 12′, and payment device 24′ are shown with primes to emphasize that the redemption of the rebate need not take place at the same location as where a rebate is issued, although a similar arrangement may be used both for issuance of rebates and for redemption of rebates.

Thus, like the embodiment illustrated in FIG. 1, the system 60 shown in FIG. 6A includes a host computer system 14′ that is configured for interaction with a point-of-sale device 12′ and a payment device 24′. The point-of-sale device 12′ may have a capacity comparable to that of the point-of-sale device 12 described previously and shown schematically in FIG. 2. In particular, it may be employed to capture information needed to complete the purchase of an item as part of a rebate redemption, including bar-code reader components, magnetic-stripe reader components, payment-information entry components, signature-capture components, key pads, keyboards, display screens, biometric data capture components, speakers, printers, processors, software, memory, communication devices, and the like. This capacity may also be used to collect information directly from a rebate itself to define conditions for the rebate. For example, when a rebate is initially issued, a rules file may be provided to the host computer identifying that rebate with a UPC number and defining the conditions for its redemption. The file may contain such information as what specific item must be purchased in order for the rebate to apply, applicable time limitations on the rebate, and the like. In applicable instances, the file may contain information defining combinations of items that must be purchased at the same time for the rebate to apply. The UPC number may be extracted from the rebate by a bar-code reader comprised by the point-of-sale device, and may be used as an identifier for the rebate in subsequent reconciliation processes.

The host computer system 14′ is additionally configured to interact with a payment system 70 that may coordinate transfers of funds within the financial network to effect the reconciliation of rebates. A portion of a network is shown in FIG. 6A that includes a manufacturer financial institution 66 and a retailer financial institution 68. While the manufacturer financial institution 66 and retailer financial institution 68 are shown as separate entities, it is possible in some embodiments for them to be the same entity. These financial institutions usually hold monetary accounts for the respective parties, such as banks, credit unions, and the like, but may more generally include institutions that hold accounts for parties using any form of value, such as stock brokerages, mutual-fund institutions and the like. Thus, the manufacturer financial institution 66 holds a manufacturer account 62 on behalf of a manufacturer of the item being purchased during the redemption of the rebate. The manufacturer may be considered to be the originator of the rebate and is ultimately responsible for providing funds or other forms of value in accordance with the terms of the rebate. The retailer financial institution 68 holds a retailer account 64 on behalf of the retailer, who may be identified as the selling party in the redemption transaction.

In order to effect reconciliation of the rebate, the host computer system 14′ may include a set of rules provided to it by the manufacturer and/or retailer to specify which financial institutions and accounts may be accessed by the payment system 70 when processing a rebate. Such a rule set is in addition to the rule set maintained by the host computer system 14′ to implement the mechanical aspects of the rebate, such as the specification of criteria required for redemption of the rebate and the like. These rule sets may conveniently be provided to the host computer system 14′ electronically from the manufacturer when the manufacturer initiates a rebate program.

In the flow diagram of FIG. 6B, one embodiment for using the system arrangement 60 shown in FIG. 6A for reconciling a rebate is illustrated. In some embodiments, a real-time reconciliation of a rebate may be provided by performing the steps at the time of redemption of the rebate. In other embodiments, information relating to the redemption may be collected throughout a period of time, such as a day, with some of the steps shown in FIG. 6B being performed with the collected information periodically in a batch mode. Both such implementations are within the scope of the invention.

Thus, after a customer selects an item for purchase that is believed to correspond to the terms of a rebate, the customer presents himself at a station to redeem the rebate. In some embodiments, the rebate may comprise an individual rebate issued specifically to that customer, while in other embodiments the rebate may be one of a large number of mass produced and distributed rebates sometimes referred to in the industry as “coupons.” At block 102, the item information is entered into the point-of sale device 12′, such as by scanning a bar code affixed to the item. Often, the item may be one of several items being purchased at that time by the customer. Accordingly, at block 106, the customer tenders payment for the purchase, including a tender of the rebate. The rebate information is collected at block 110 and entered into the point-of-sale device 12′, such as by scanning a bar code printed on the rebate. The host computer system 14′ receives the item information and the rebate information from the point-of-sale device 12′ and at block 114 verifies that the rebate applies to the item. This may be done by using the UPC code scanned from the rebate to look up applicable rules in the rules file maintained by the host computer system 14′, which may similarly identify suitable rebate items by their own UPC codes. In other embodiments, the rebate information may be derived from an association between the item and the rebate; for example, the bar code on the item may be read and then checked against the rules set to determine whether a rebate applies.

After it has been verified that the rebate applies to the item, redemption of the rebate is reconciled. The host computer system 14′ issues an instruction through the payment system 70 for reimbursement of the amount of the rebate to be applied by the retailer. This transfer is effected by the payment system 70 issuing a first instruction at block 118 to the manufacturer financial institution to debit the manufacturer account by at least the amount of the rebate; in some embodiments, the debit amount may exceed the rebate amount to account for a service charge applied by the payment system 70 and/or the retailer in redeeming the rebate. This debit is accompanied by an instruction at block 122 to the retailer financial institution to credit the retailer account by at least the amount of the rebate; if a service charge is paid to the retailer for the redemption, the credited amount may exceed the rebate amount.

If the reconciliation is performed in real time, completion of the transaction may wait for verification that the retailer account has been credited at block 126 so that the redeemed rebate is applied to the item at block 130. In instances where the reconciliation is performed in batch mode, however, the rebate may be applied to the item immediately after the verification performed at block 114. In such instances, the host computer 14′ accumulates information throughout the day (or other period) identifying which rebates have been redeemed, their rebate amounts, and the manufacturers responsible for reimbursement of the amounts. This accumulated information is transmitted to the payment system 70 at the end of the day (or other period). In such a batch mode, the payment system may receive files from multiple host computer systems 14′ at a variety of locations where rebates are redeemed, with each file identifying multiple manufacturers. The payment system 70 thus extracts information for each manufacturer from each of the received files to calculate a total amount due from that manufacturer. When instructing respective manufacturer financial institutions 66 to debit respective manufacturer accounts 62 at block 118, the cumulative totals of the redemption amounts may be requested, perhaps augmented by appropriate service charges. Similarly, when instructing respective retailer financial institutions 68 to credit respective retailer accounts 64 at block 122, the cumulative totals due to the respective retailers may be provided, perhaps augmented by appropriate service-charge amounts. An accounting is generally also provided to each of the manufacturers and retailers indicating in detail which rebates have been reconciled in accordance with this process. In such embodiments, the UPC codes for both the rebates reconciled and for the associated items may be used for identification in the accounting. The accounting may be accompanied with a shipment of the redeemed rebates for auditing purposes.

These reconciliation methods may be implemented by a computer system that comprises a payment-system computer having an input interface and an output interface, and a memory associated with the payment-system computer. The payment-system computer is configured to receive the information from the multiple retailers at the input interface and to issue the instructions for debiting and crediting account at the output interface.

The invention has now been described in detail for purposes of clarity and understanding. However, it will be appreciated that certain changes and modifications may be practiced within the scope of the appended claims.

What is claimed is:

1. A method for providing a rebate, the method comprising:
receiving at a host computer rebate information associated with at least one item for sale and reimbursement information relating to the rebate;
receiving at the host computer redemption information on a redeemed rebate; and
transmitting from the host computer a request for reimbursement based on the reimbursement information and the redemption information.

2. The method recited in claim 1 wherein transmitting the request for reimbursement comprises transmitting from the host computer to a payment system a request to debit an account associated with a manufacturer of the at least one item.

3. The method recited in claim 1 wherein transmitting the request for reimbursement comprises transmitting from the host computer to a payment system a request to credit an account associated with a seller of the at least one item.

4. The method recited in claim 1 wherein transmitting the request for reimbursement is performed substantially contemporaneously with redemption of the rebate.

5. The method recited in claim 1 wherein the request for reimbursement is one of a plurality of simultaneously transmitted requests for reimbursement.

6. The method recited in claim 1 further comprising applying the redeemed rebate to the at least one item.

7. The method recited in claim 1 wherein receiving rebate information associated with the at least one item comprises scanning a bar-code symbol for the at least one item.

8. The method recited in claim 1 wherein receiving redemption information on the redeemed rebate comprises scanning a bar-code symbol for the rebate.

9. A computer system for providing a rebate, the system comprising:
a host computer having an input interface and an output interface; and
a memory device associated with the host computer,
wherein the host computer is configured to receive at the input interface rebate information associated with at least one item for sale, reimbursement information relating to the rebate, and redemption information on a redeemed rebate, and to transmit at the output interface a request for reimbursement based on the reimbursement information and the redemption information.

10. The computer system recited in claim 9 wherein the request for reimbursement comprises a request to debit an account associated with a manufacturer of the at least one item.

11. The computer system recited in claim 9 wherein the request for reimbursement comprises a request to credit an account associated with a seller of the at least one item.

12. The computer system recited in claim 9 wherein the request for reimbursement is transmitted substantially concurrently with redemption of the rebate.

13. The computer system recited in claim 9 wherein the request for reimbursement is transmitted as one of a plurality of simultaneously transmitted requests for reimbursement.

14. The computer system recited in claim 9 wherein the rebate information associated with the at least one item is received from a scan of a bar-code symbol for the at least one item.

15. The computer system recited in claim 9 wherein the redemption information on the redeemed rebate is received from a scan of a bar-code symbol for the rebate.

16. A method for reconciling rebates, the method comprising:
receiving, from each of a plurality of retailers, information setting forth a plurality of redeemed rebates, each such redeemed rebate being associated with a manufacturer and with a rebate amount; and
transmitting a request to effect a transfer of funds from an account of at least one of the manufacturers to an account of at least one of the retailers in accordance with the rebate amounts.

17. The method recited in claim 16 wherein transmitting the request comprises:
transmitting a first instruction to a first financial institution to debit the account of the at least one of the manufacturers in accordance with the rebate amounts; and
transmitting a second instruction to a second financial institution to credit the account of the at least one of the retailers in accordance with the rebate amounts.

18. The method recited in claim 17 further comprising deriving a total debit amount for each of the manufacturers from the information received from the plurality of retailers, wherein the first instruction sets forth the total debit amount for the at least one of the manufacturers.

19. The method recited in claim 18 wherein the total debit amount includes a service charge.

20. The method recited in claim 17 further comprising deriving a total credit amount for each of the retailers from the information received from such each of the retailers, wherein the second instruction sets forth the total credit amount for the at least one of the retailers.

21. The method recited in claim 16 wherein the information setting forth the plurality of redeemed rebates identifies each of the redeemed rebates with a UPC code.

22. The method recited in claim 16 further comprising providing an accounting to the at least one of the manufacturers.

23. The method recited in claim 16 further comprising providing an account to the at least one of the retailers.

24. A method for reconciling a rebate, the method comprising:
receiving a request for reimbursement of a rebate amount for a rebate redeemed by a retailer, wherein the rebate originates with a manufacturer;
transmitting a first instruction to a first financial institution to debit an account of the manufacturer of at least the rebate amount; and
transmitting a second instruction to a second financial institution to credit an account of the retailer of at least the rebate amount.

25. The method recited in claim 24 further comprising transmitting verification of a credit to the account of the retailer to the retailer.

26. The method recited in claim 25 wherein transmitting verification of the credit is performed before the rebate amount is applied to a sale of an associated item.

27. A computer system for reconciling rebates, the computer system comprising:
a payment-system computer having an input interface and an output interface; and
a memory device associated with the payment-system computer,
wherein the payment-system computer is configured to:
receive at the input interface, from each of a plurality of retailers, information setting forth a plurality of redeemed rebates, each such redeemed rebate being associated with a manufacturer and with a rebate amount; and
transmit at the output interface a request to effect a transfer of funds from an account of at least one of the manufacturers to an account of at least one of the retailers in accordance with the rebate amounts.

28. The computer system recited in claim 27 wherein the payment-system computer is further configured to:
transmit at the output interface a first instruction to a first financial institution to debit the account of the least one of the manufacturers in accordance with the rebate amounts; and
transmit at the output interface a second instruction to a second financial institution to credit the account of the at least one of the retailers in accordance with the rebate amounts.

29. The computer system recited in claim 28 wherein the payment-system computer is further configured to derive a total debit amount for each of the manufacturers from the information received from the plurality of retailers, wherein the first instruction sets forth the total debit amount for the at least one of the manufacturers.

30. The computer system recited in claim 29 wherein the total debit amount includes a service charge.

31. The computer system recited in claim 28 wherein the payment-system computer is further configured to derive a total credit amount for each of the retailers from the information received from such each of the retailers, wherein the second instruction sets forth the total credit amount for the at least one of the retailers.

32. The computer system recited in claim 27 wherein the information setting forth the plurality of redeemed rebates identifies each of the redeemed rebates with a UPC code.

33. A computer system for reconciling rebates, the computer system comprising:
a payment-system computer having an input interface and an output interface; and
a memory device associated with the payment-system computer,
wherein the payment-system computer is configured to:
receive a request for reimbursement of a rebate amount for a rebate redeemed by a retailer, wherein the rebate originates with a manufacturer;
transmit a first instruction to a first financial institution to debit an account of the manufacturer of at least the rebate amount; and
transmit a second instruction to a second financial institution to credit an account of the retailer of at least the rebate amount.

34. The computer system recited in claim 33 wherein the payment-system computer is further configured to transmit verification of a credit to the account of the retailer to the retailer.

35. The computer system recited in claim 33 wherein the verification is transmitted before the rebate amount is applied to a sale of an associated item.
